(19) United States
(12) Patent Application Publication
(10) Pub. No.: US 2004/0056954 A1
(43) Pub. Date: Mar. 25, 2004

(54) System and method for monitoring within a vehicle

(76) Inventors: John Christopher Crandall, Fort Collins, CO (US); Carla Amanda Pasetti, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/252,856

(22) Filed: Sep. 20, 2002

(51) Int. Cl. H04N 7/18

(52) U.S. Cl. 348/148

(57) ABSTRACT

Disclosed is a monitoring system for a vehicle comprising an image capturing device maintained in relationship to an area of interest within the vehicle, a monitor for viewing images from the image capturing device, and a triggering mechanism for enabling the image capturing device to capture images from within the area of interest.

### CROSS-REFERENCE TO RELATED APPLICATIONS

The present application is related to commonly-assigned U.S. patent application [Attorney Docket No. 1001883-1] entitled “SYSTEM AND METHOD FOR CAPTURING IMAGES BASED UPON SUBJECT ORIENTATION,” U.S. patent application [Attorney Docket No. 10018893-1] entitled “SYSTEM AND METHOD FOR CONTROLLING SERVICE DELIVERY,” and U.S. patent application [Attorney Docket No. 10018886-1] entitled “SYSTEM AND METHOD FOR WIRELESSLY VIEWING RESTRICTED DATA,” filed on the same date herewith, the disclosures of which are hereby incorporated by reference in their entireties.

### BACKGROUND

Often, it is desirable for an observer to be able to see what is occurring at a particular location that is, perhaps temporarily, out of the visual range of the observer. By way of example, not many parents, or grandparents, have been spared from the predicament of driving a motor vehicle with a young child or infant being restrained in a back seat, out of the view of the driver, and the driver having the sensation (by hearing a noise, feeling a movement or just plain instinct) that something is wrong with the child. Perhaps it is as simple as a toy having been dropped, or the child coughing. Sometimes, it is life-threatening, such as when the child has swallowed the toy, or is gagging on a pretzel.

Until the driver can ascertain that the child is safe, tension arises in the driver, impairing the driver's ability to concentrate on his/her driving. At some point, it becomes imperative for the driver to turn his/her head to see what is the true situation with the child. Unless the driver finds a safe place to stop the vehicle, the driver, by turning his/her head to observe the problem, takes his/her attention away from driving and places the vehicle, the occupants of the vehicle, as well as other people and property, in great peril.

### SUMMARY

Embodiments of the present inventive teachings provide a monitoring system for a vehicle, comprising an image capturing device maintained in relationship to an area of interest within the vehicle, a monitor for viewing images from the image capturing device, and a triggering mechanism for enabling the image capturing device to capture images from within said area of interest.

Additionally, embodiments of the present inventive teachings provide a multi-functional vehicle monitor comprising a visual display adapted for mounting within the vehicle at a position within the view of an operator of the vehicle, a controller for providing to the display a plurality of images and a plurality of inputs for receiving image data from at least two sources, one of the sources being a monitoring system for providing images of an area within the vehicle, and the other source being any other source of video data.

Embodiments of the present inventive teachings further provide a child restraining device for use in a vehicle comprising a portion for restraining a child, an image capturing device positioned to capture images of a child being restrained, and an output for supplying signals representative of captured images to a monitor located remotely from the restraining device.

Embodiment of the present inventive teachings provide method for viewing a portion of a vehicle, comprising capturing images of selected portions of the interior of the vehicle, and displaying the captured ones of the images such that an operator of the vehicle can view the displayed images while maintaining a field of view.

### BRIEF DESCRIPTION OF THE DRAWINGS

FIG. 1 is an overview of one embodiment of a system according to the teachings of the invention;

FIG. 2 is a detailed system diagram of the embodiment shown in FIG. 1; and

FIG. 3 is a flow diagram showing the operation of one embodiment of a system according to the teachings of the invention.

### DETAILED DESCRIPTION

The present invention is directed to a system and method for monitoring within a vehicle. In one embodiment, at least one visual image is captured of a child restrained in a car seat. The visual image is triggered under at least one circumstance. For example, the image could be captured on demand by the driver, upon movement or sound utterances of the child, by a periodic timer, or continuously. The visual image, when captured, may be provided to a monitor, viewable by the driver.

FIG. 1 is an overview of one embodiment of a system according to the invention in which there is shown system 10 deployed in vehicle 11 having front seat 13 and back seat 12. In front seat 13 driver 17 is facing the front of the vehicle. Positioned in the driver's view is a visual display or monitor such as display 18 which can have alternate positions such as at location 19. Display 18 could, in one embodiment, be dedicated to this system or, in another embodiment, display 18 is shared with other visual images, such as speed, radio, a Global Positioning System (GPS), or compass. Generally, such a monitor would be mounted in the vehicle such that its position relative to the drivers field of vision would be constant. Securely fastened to rear seat 12 is car seat 14 having positioned therein child 15. Positioned optionally on one side of child 15 is device 101, such as may comprise a microphone or other audio transducer, which is designed to pick up sound. Also positioned optionally is device 102, such as may comprise passive infrared circuitry or other movement sensors, which is designed to detect movement. While movement detector 102 is shown on one side it is understood that such a device, if used, might be positioned around child 15 to detect movement in any direction.

Image capture device 16, which may comprise a charge-coupled device (CCD) or other image transducer, can be positioned on car seat 14, on the rear surface of the front seat, on the inside roof of vehicle 11, or at any other location suitable for capturing images of child 15. Device 16 would preferably be focused on car seat 14. Device 16 can be digital if desired and also can capture still images as well as video images for display on screen 18 (19).

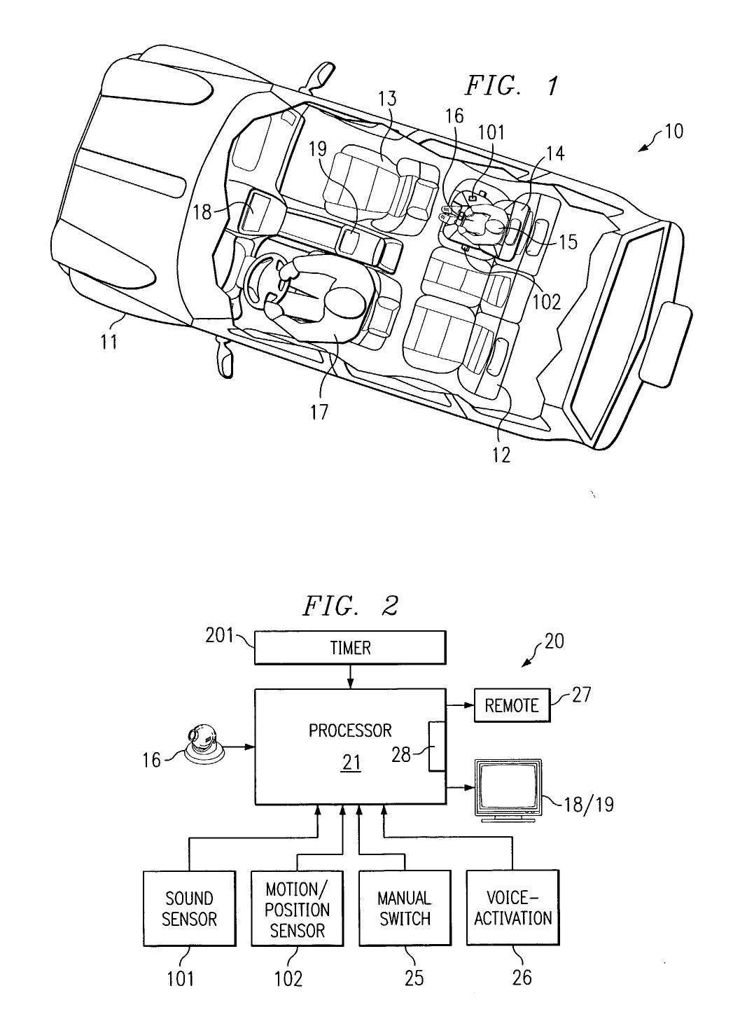

FIG. 2 is a detailed system diagram of the embodiment shown in FIG. 1 which shows system 20, having image capture device 16 which feeds information (wirelessly, if desired) to processor 21. Processor 21 may be controlled, if desired, by timer 201, by motion sensor 102, by sound sensor 101, and/or by manual switch 25 used by the motor vehicle operator, or someone remote to the vehicle, to turn on the image capture device to receive an image at monitor 18 (19). Manual switch 25 can, if desired, be replaced (or supplemented) by voice-activated switch 26 operable upon command of the driver. Processor 21 can be located in conjunction with seat 14, in conjunction with display 18 (19), or at any other convenient location.

The image signal output from processor 21 can be sent to display 18 (19) or can be sent remotely via sender 27. Alternatively, display 18 (19) is a monitor associated with another user display and the output could be a cord (or wireless signal) output 28 for sending video image information to an existing monitor. Note that in one embodiment the image data is controlled by a processor already present in the vehicle.

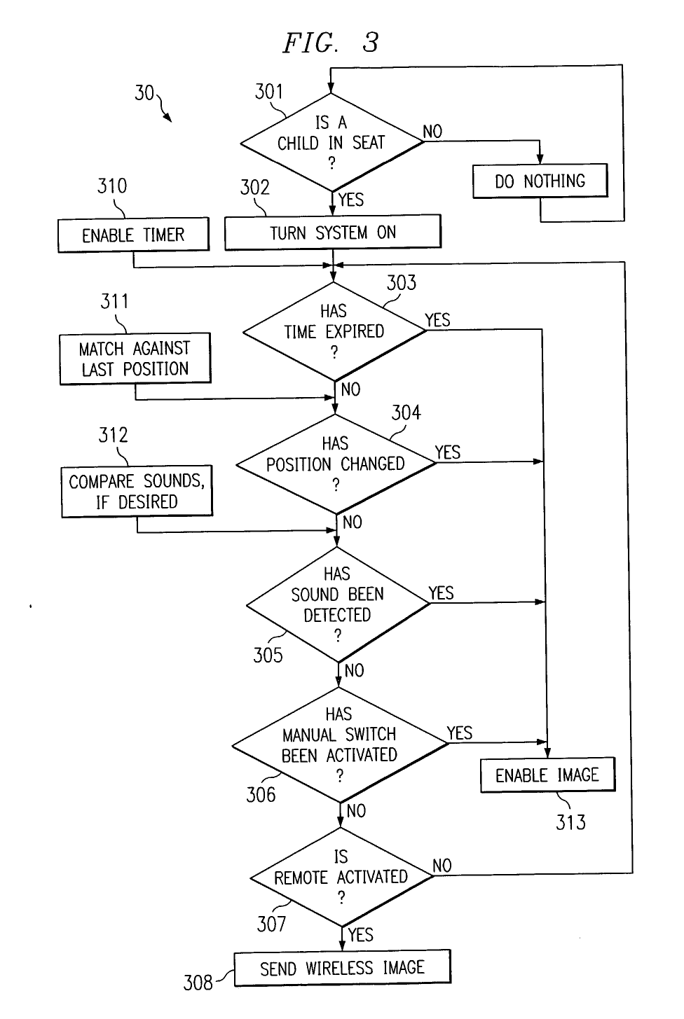

FIG. 3 is flow diagram 30 showing the operation of one embodiment of a system according to the teachings of the invention. Process 301 determines if there is a child in the seat. In situations where other objects are to be monitored, this process would determine if such other objects are present. If the child (or other object) is in the seat (or in the portion to be monitored), then process 302 turns the system on and a determination is made via process 303 and 310 if a predetermined amount of time has elapsed. If the predetermined amount of time has elapsed, then it is time to capture an image and image enabler process 313 is activated. If sufficient time has not elapsed, then a check via process 304 is made to determine whether the child's position has changed. If the position has changed, then image enabler 313 is activated. The determination of a position change could be by sensors 102, but could also be accomplished by process 311 which checks the latest position against the last position such as may be accomplished using a series of images. Also, pressure sensitive devices may be used to determine both presence of an object and movement of that object. Process 305 determines if sound (or if a certain sound) has been detected. If so, then image enabler 313 is activated.

The system could be designed to have continuous images displayed, if desired. Also, the system can be designed to detect when a new position, process 311 (or sound, process 312) is abnormal by comparison to prior positions and/or to a data base of known improper positions and sounds, thereby capturing the image and alerting the driver. Abnormal positions could be determined for example, by activation of certain pressure or position sensors by the object being monitored.

Process 306 checks to see if a manual switch (or voice activation) has been enabled. If it has, image enabler 313 is activated. Process 307 checks to see if there has been a remote activation. If there has been a remote activation, then images are sent to a designated party via wireless e-mail or otherwise via process 308. This enables a person to remotely monitor a trip of a loved one. Of course, remote transmission of images may be provided in response to any of the aforementioned image activation circumstances as well, if desired.

Note that when an image is being changed, display 18 can be adapted to provide a sound or a statement to the driver pertaining to the change, and if desired, provide information to the driver in audible fashion. The sound could be generated by well-known techniques within processor 21 and the sound transducer could be within display 18 or external thereto, such as for example, the vehicle's radio speaker (not shown). The audible message could be indicative of or associated with the specific image type, the image activation circumstances, and/or the like.

Note that the wireless connections can use any protocol, such as Bluetooth or the 802.11 protocol. Also, note that any of the sensors for controlling image capturing can be eliminated and only a single activation used. If continuous video is used, then the system would work at all times.

In one embodiment, the monitor is shared with other images available to the driver, such as, for example, GPS, radio or television (TV) display, maps and compass headings. The display could be a projection into the visual path of the driver, such as by using heads-up display technology. When the images captured by an embodiment of this invention are displayed on a screen with GPS (or other displays) they can be concurrently display or serially interleaved. The system could alternate between the images of the object(s) of concern and other information, or optionally only display the child for selected periods of time, controlled by timer 201, or switch 25, or voice-command. If an abnormal situation is detected, as discussed above, the image capture and display could be switched to automatic and then become continuous, for a period of time.

While a child car seat is shown in the embodiment, the concepts taught enable the image capture device to be focused on any portion of a vehicle and on any object and could even change position and focus on command of the driver, or by timer or otherwise. Objects to be monitored could be pets, cargo, people with infirmaties, and the system could switch between such objects, either manually, or by time or by sounds and/or motion, all as discussed above. Also, note that the term vehicle includes all rolling stock, whether or not it has its own power and will include, by way of example, cars, trucks, planes, trains, buses, trailers and boats.

Also note that when the term field of view is used it is meant to refer to the normal area seen by an operator of a vehicle when the vehicle is being operated in a safe manner. Thus, for a motor vehicle, the field of view of the driver would be generally out of the windscreen of the vehicle facing forward.

What is claimed is:

1. A monitoring system for a vehicle, said system comprising:
an image capturing device maintained in relationship to an area of interest within said vehicle;
a monitor for viewing images from said image capturing device; and
a triggering mechanism for enabling said image capturing device to capture images from within said area of interest.

2. The system of claim 1 wherein said triggering mechanism comprises:
a positional detector for detecting the position of objects within said area of interest.

3. The system of claim 1 wherein said area of interest comprises a restraining device.

4. The system of claim 3 wherein said restraining device is designed to restrain a person.

5. The system of claim 4 wherein said person is a child.

6. The system of claim 1 wherein said triggering mechanism comprises:
a movement detector for detecting the movement of an object within said area of interest.

7. The system of claim 6 wherein said area of interest comprises a restraining device.

8. The system of claim 7 wherein said restraining device is designed to restrain a person.

9. The system of claim 8 wherein said person is a child.

10. The system of claim 1 wherein said triggering mechanism comprises the detection of abnormal events within said area of interest.

11. The system of claim 10 wherein said area of interest comprises a restraining device.

12. The system of claim 11 wherein said restraining device is designed to restrain a person.

13. The system of claim 12 wherein said person is a child.

14. The system of claim 1 wherein said triggering mechanism comprises:
an operator enabling switch.

15. The system of claim 1 wherein said triggering mechanism comprises:
a timer for activating said trigger mechanism from time to time.

16. The system of claim 1 wherein said triggering mechanism comprises:
a sound detector positioned to detect sounds from within said area of interest.

17. The system of claim 16 wherein said area of interest comprises a restraining device.

18. The system of claim 17 wherein said restraining device is designed to restrain a person.

19. The system of claim 18 wherein said person is a child.

20. The system of claim 1 wherein said image capturing device captures images in an area of interest that is out of the field of view of an operator of said vehicle while said operator is operating said vehicle and wherein said monitor is designed for positioning within said operator's field of view while said operator is operating said vehicle.

21. The system of claim 20 wherein said monitor is permanently attached to said vehicle.

22. The system of claim 20 wherein said monitor also provides other visual displays to said operator.

23. The system of claim 22 wherein said other visual displays are interleaved with images from said monitor.

24. The system of claim 1 further comprising an audible alert for calling attention to a captured image.

25. The system of claim 1 further comprising:
a wireless transmitter for sending at least one of the captured images to a location outside of said vehicle.

26. The system of claim 1 wherein said trigger mechanism is activated from outside said vehicle.

27. A multi-functional vehicle monitor, said monitor comprising:
a visual display adapted for mounting within said vehicle at a position within the field of view of an operator of said vehicle;
a controller for providing to said display a plurality of images; and
a plurality of inputs for receiving image data from at least two sources, one of said sources being a monitoring system for providing images of an area within said vehicle, and the other source being any other source of video data.

28. The system of claim 27 wherein said area within said vehicle comprises a child restraining device positioned outside the operator's field of view when said operator is operating said vehicle.

29. A restraining system for use in a vehicle, said system comprising:
means for restraining a person;
means for capturing images of a person being restrained; and
means for supplying signals representative of captured images to a monitor.

30. The restraining system of claim 29 further including means for transmitting supplied signals to a location remotely situated from said restraining device.

31. The restraining system of claim 29 wherein said restraining means further comprises means for enabling said image capturing device.

32. The restraining system of claim 31 wherein said enabling means is at least one selected from the list of: sound detection, motion detection, positional detection, remote triggering and operator initiated.

33. The restraining system of claim 31 further comprising means for providing an audible signal in conjunction with a captured image.

34. A method for viewing a portion of a vehicle, said method comprising:
capturing images of selected portions of the interior of said vehicle; and
displaying the captured images such that an operator of said vehicle can view said displayed images while maintaining a field of view.

35. The method of claim 34 wherein said captured images are displayed on a display device shared with other images displayed to said driver.

36. The method of claim 34 comprising periodically enabling said capturing process.

37. The method of claim 34 further comprising enabling said capturing images upon the occurrence of at least one of the events in the following list: sounds from a vehicle occupant, motion of a person within said selected portion, position of an object within said selected portion, manual activation by said operator and periodic time activation.
